(19) United States
(12) Patent Application Publication
(10) Pub. No.: US 2017/0277182 A1
(43) Pub. Date: Sep. 28, 2017

(54) CONTROL SYSTEM FOR SELECTIVE AUTONOMOUS VEHICLE CONTROL

(71) Applicant: MAGNA ELECTRONICS INC., Auburn Hills, MI (US)

(72) Inventors: Benjamin May, Lübs (DE); Joern Ihlenburg, Berlin (DE)

(21) Appl. No.: 15/463,294

(22) Filed: Mar. 20, 2017

Related U.S. Application Data
(60) Provisional application No. 62/312,795, filed on Mar. 24, 2016.

(51) Int. Cl. G05D 1/00; B60W 50/08

(52) U.S. Cl. CPC G05D 1/0061; B60W 50/082; B60W 2540/04; B60W 2540/22; B60W 2420/52; B60W 2420/42

(57) ABSTRACT

A vehicle control system for a vehicle includes a plurality of sensors disposed at a vehicle and having respective fields of sensing exterior of the vehicle. A processor is operable to process data captured by the sensors, and a control, responsive to processing by the processor of data captured by the sensors, controls a plurality of vehicle systems and is capable of autonomous control of the vehicle to autonomously drive the vehicle along a road. The vehicle control system includes a user input that is selectively actuatable by an occupant of the vehicle so that the occupant can select one of at least (i) a non-autonomous mode where the occupant has driving control of the vehicle and non-autonomously drives the vehicle along the road, and (ii) an autonomous mode where said control autonomously drives the vehicle along the road.

### CROSS REFERENCE TO RELATED APPLICATION

The present application claims the filing benefits of U.S. provisional application, Ser. No. 62/312,795, filed Mar. 24, 2016, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

BASt, SAE, OICA and NHTSA have defined levels in terms of the extent an automated vehicle is equipped for automated driving. For example, SAE and NHTSA have the states as Level 0: driver only (no automation—the driver is in complete and sole control of the primary vehicle controls, including braking, steering, throttle and motive power, at all times) Level 1: Assisted (Function-specific Automation: automation at this level involves one or more specific control functions, examples include electronic stability control or pre-charged brakes, where the vehicle automatically assists with braking to enable the driver to regain control of the vehicle or stop faster than possible by acting alone), Level 2: Partial Autonomous (Combined Function Automation: this level involves automation of at least two primary control functions designed to work in unison to relieve the driver of control of those functions, an example of combined functions enabling a Level 2 system is adaptive cruise control in combination with lane centering), Level 3: Conditional Autonomous (Limited Self-Driving Automation: vehicles at this level of automation enable the driver to cede full control of all safety-critical functions under certain traffic or environmental conditions and in those conditions to rely heavily on the vehicle to monitor for changes in those conditions requiring transition back to driver control, the driver is expected to be available for occasional control, but with sufficiently comfortable transition time), Level 4: High Autonomous, and Level 5: Full Autonomous (Full Self-Driving Automation: the vehicle is designed to perform all safety-critical driving functions and monitor roadway conditions for an entire trip, such a design anticipates that the driver will provide destination or navigation input, but is not expected to be available for control at any time during the trip, this includes both occupied and unoccupied vehicles) (see FIGS. 4 and 5 for the different levels and descriptions for BASt, SAE, OICA and NHTSA). Today OEM's and suppliers have Level 2 in production and work on achieving level 3 features. Daimler lately has announced its new E-Class featuring self-driving capabilities on highway type roads which means it will meet ‘Conditional Automation’ according to SAE Level 3. Higher levels than SAE level 3 are in development so far and will take a while until these will get released to public roads, especially the levels where the driver is released to paying attention to the vehicle's driving.

### SUMMARY OF THE INVENTION

The present invention provides a driver assistance system or autonomous vehicle control system that is selectively adjustable to provide a driver desired or selected or appropriate level of autonomous control of the vehicle. The system may, for example, have a user input (such as a dial or sliding switch or the like) that allows the driver to select the level of autonomous control of the vehicle for the particular or desired driving situation. The driver may select any desired level (between no autonomous control or full driver control and full autonomous control) for the driving experience desired at that time. Optionally, the system may determine driver characteristics and, responsive at least in part to the determined driver characteristics, may automatically provide an appropriate level of control of the vehicle or an appropriate driving characteristic of the vehicle.

These and other objects, advantages, purposes and features of the present invention will become apparent upon review of the following specification in conjunction with the drawings.

### BRIEF DESCRIPTION OF THE DRAWINGS

FIG. 1 is a schematic of various considerations to the vehicle manufacturer and driver for different control of the vehicle;

FIG. 2 is a block diagram of different considerations the driver may have for wanting autonomous or non-autonomous control of the vehicle;

FIG. 3 is a schematic of a user adjustable input that allows the driver of the vehicle to adjust the level of vehicle control in accordance with the present invention;

FIGS. 4 and 5 are charts showing definitions of the different levels of autonomous vehicle control and descriptions of those levels for BASt, SAE, OICA and NHTSA; and

FIG. 6 is a chart of the system that get engaged, optionally offered or not engaged in accordance with the automation slider level the user is adjusting.

### DESCRIPTION OF THE PREFERRED EMBODIMENTS

The driver assistance system or autonomous vehicle control system of the present invention allows the driver of the vehicle to select the degree of autonomous control provided by the vehicle system or systems, depending on the particular driving condition and/or current driving preferences of the driver. The system includes a user adjustable input that is selectively adjustable to set the system to the driver desired or selected or appropriate level of autonomous control of the vehicle. The system may, for example, have a user input (such as a dial or sliding switch or the like) that allows the driver to select the level of autonomous control of the vehicle for the particular or desired driving situation. The driver may select any desired level (between no autonomous control or full driver control and full autonomous control) for the driving experience desired at that time.

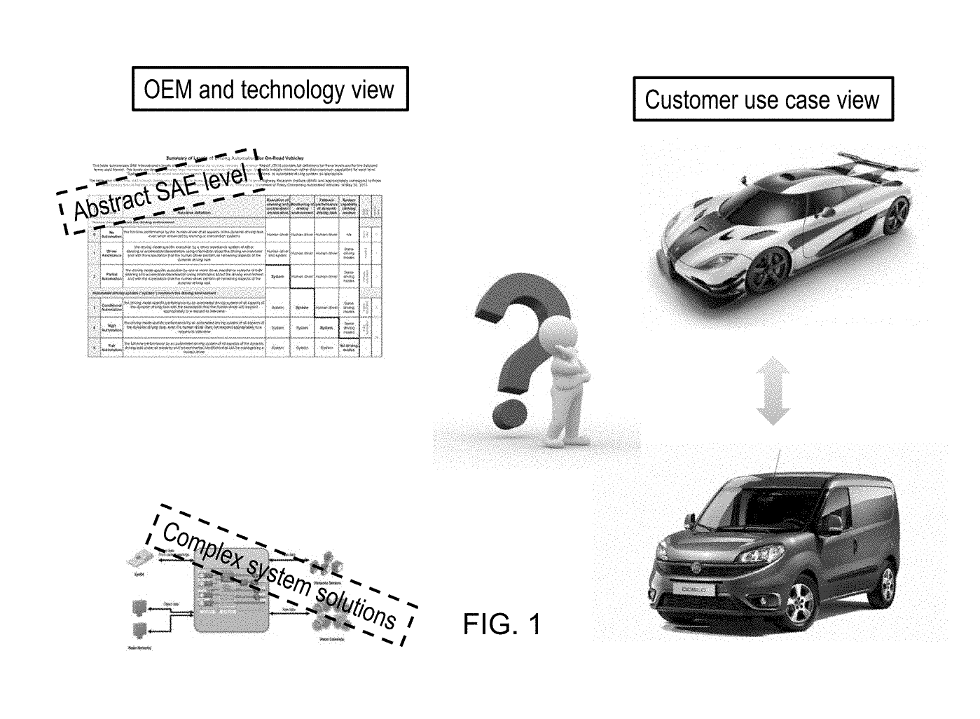

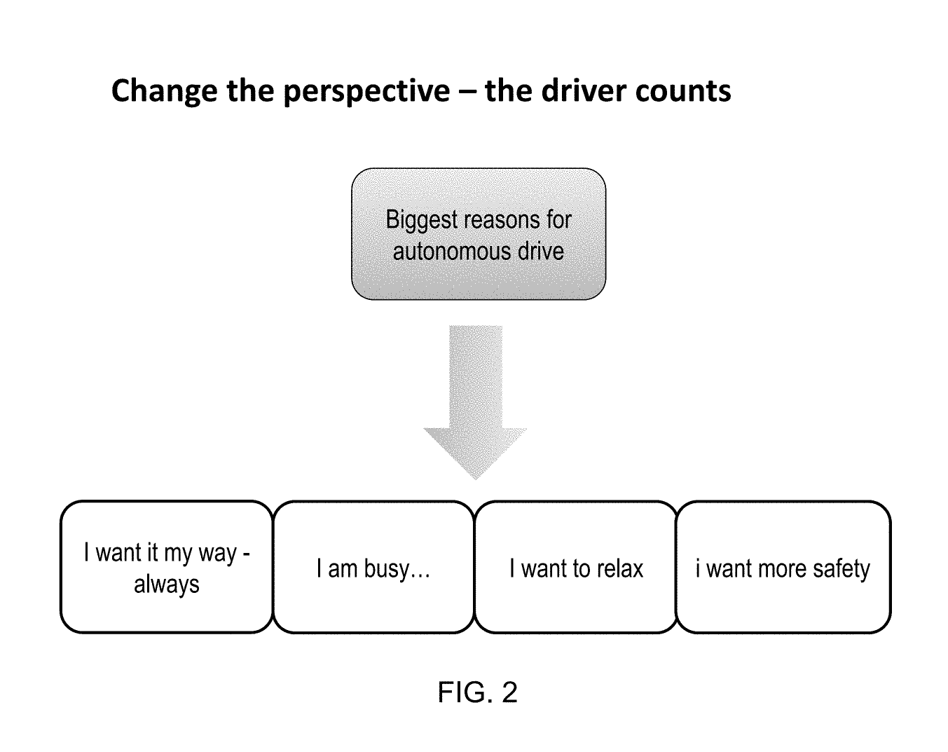

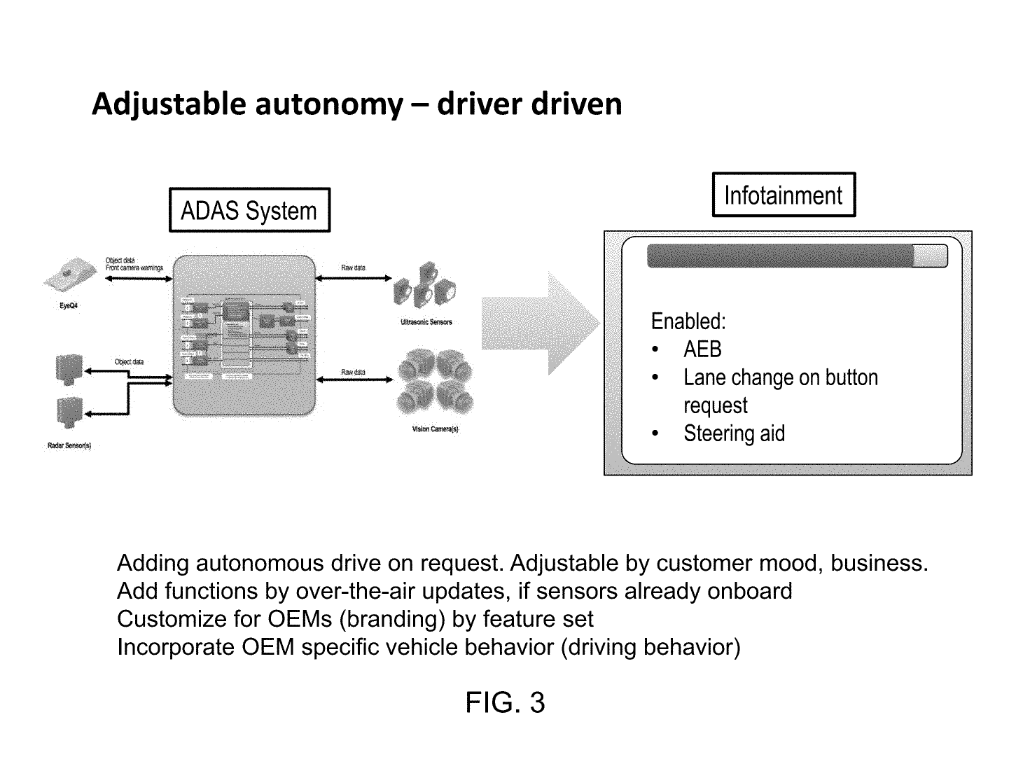

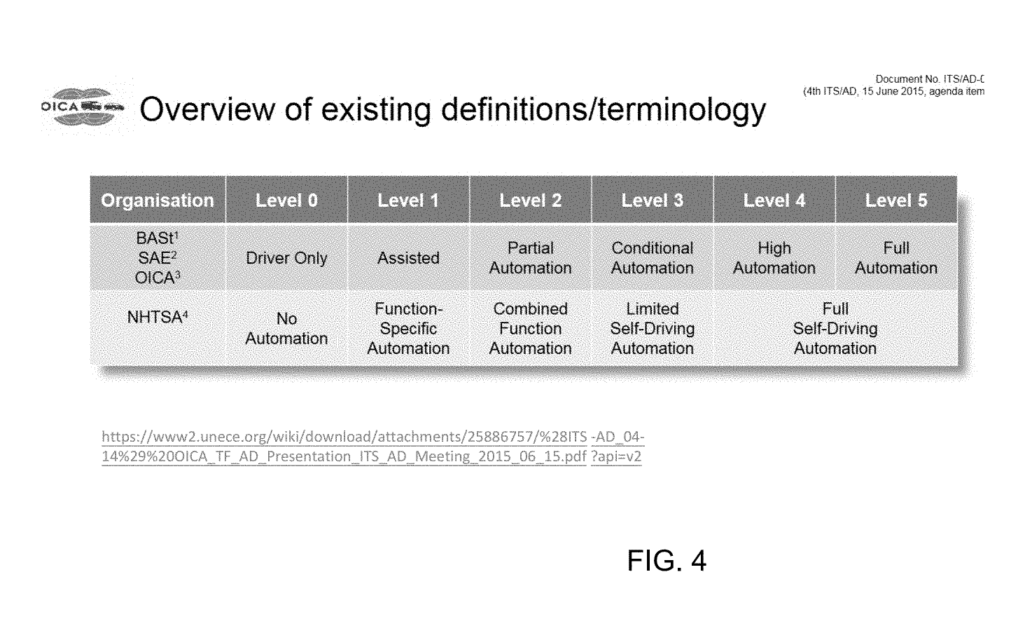

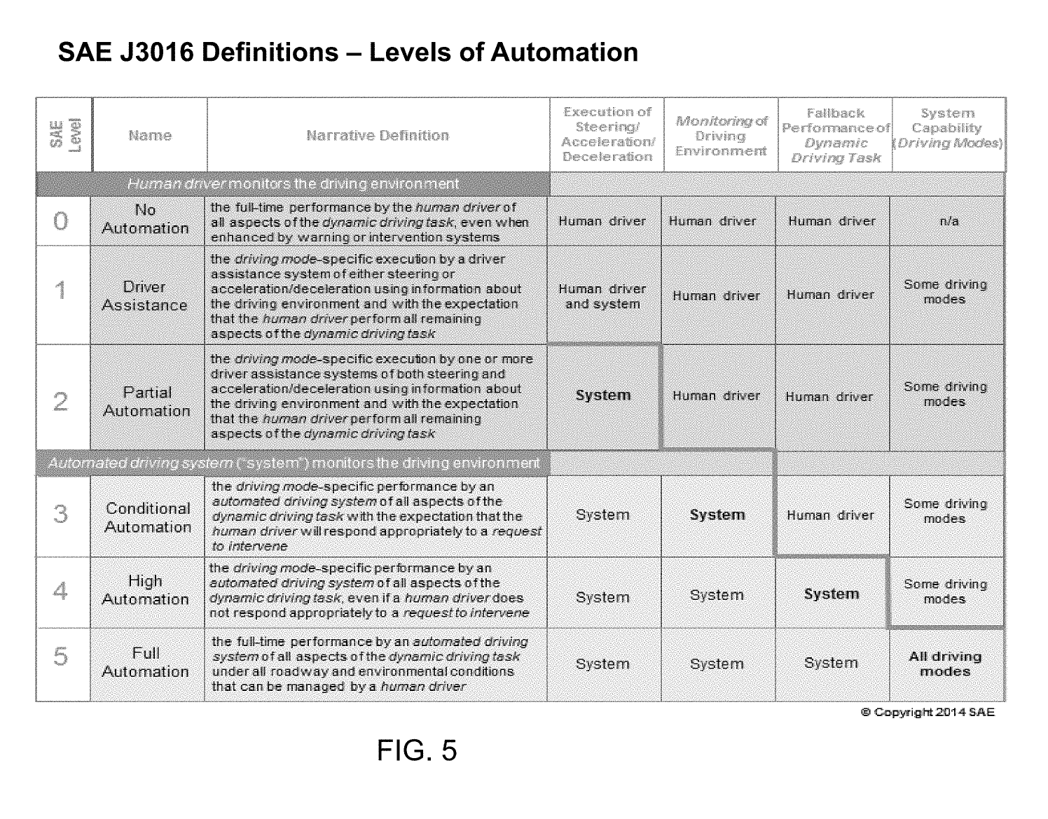

As shown in FIG. 1, the OEM or supplier may provide various levels of autonomous control and the driver may select how he wants the vehicle to operate (e.g., the driver may want a sporty or fun non-autonomous drive or may want a save and conservative autonomous drive). As shown in FIG. 2, the driver's desires may be taken into account to allow the driver to select what level of control of the vehicle he or she has (and what level of control of the vehicle the autonomous control system has). For example, and as shown in FIG. 3, the system may include a user selectable input, such as a sliding switch or the like, that allows the user to select the desired level of control. As shown in FIG. 3, when the user has selected a nearly full autonomous control, the vehicle may enable automatic emergency braking, lane change and steering aid, while still allowing some driver control. The system thus may provide fully autonomous control on request, and the degree or level or extent of driver control or vehicle control is adjustable for the driver's mood or business. Additional functions may be provided by wireless communication updates, if the sensors are already on the vehicle. The system may be customized for OEMs (adapted for different brand features) by feature sets. The system may incorporate OEM specific vehicle behavior or driving characteristics (driving behavior of the vehicle). Optionally, the system may determine driver characteristics and, responsive at least in part to the determined driver characteristics, may automatically provide an appropriate level of control of the vehicle or an appropriate driving characteristic of the vehicle.

As soon as higher automated driving levels (such as SAE level 4 and Level 5) are practically realized and implemented into vehicles on the road, there may be the desire by the vehicle driver to at some situations let the vehicle drive as full autonomously as possible, which may turn out to be a more conservative, safe and potentially boring driving approach and at other situations the driver may have the desire to take the steering wheel to have a joyride, possibly with nearly no automated and aiding functions engaged. Optionally, there may be modes at which the driver steers but receives partial automation or assist, comparable to the behavior of features of vehicles on the road today.

To ease the setting of having the one or other feature or function engaged or tuned, assuming an automated vehicle of level 4 or 5, the vehicle may possess a user friendly user input or human machine interface (HMI) for that setting. The switching on of features or functions of automation and aiding systems, optionally as well as drivetrain and suspension options, may be controlled by an instance which switches the features or functions according to a single parameter or ‘autometer’ which stands for the level of automation, but which may not be necessary but optionally may be equivalent to the automation level definitions of BASt, SAE, OICA or NHTSA. Optionally, the automation level of the autometer may be more fine-tuned than the automation levels of BASt, SAE, OICA or NHTSA.

The user HMI may consist out of a bar or slider which may be adjustable by the driver's entry. Optionally, icons or pictograms or texts of the single automation and aiding functions or features or groupings of it combined to icons or pictograms or texts may appear or may switch from gray to colored or from red to green or otherwise may be highlighted when the autometer slider is turned into a higher automation level and may disappear, may switch from colored to gray or from green to red or may otherwise lose highlighting when the slider is turned into a less automated direction.

Exemplary systems which may be turned on or off or tuned by the autometer slider may include:
Adaptive cruise control (ACC);
Adaptive high beam;
Adaptive light control: swiveling curve lights;
Automatic parking;
Automotive night vision;
Blind spot monitor;
Collision avoidance system (Precrash system);
Crosswind stabilization;
Emergency driver assistant;
Intersection assistant;
Hill descent control;
Hill-start Assist Control (HAC)/Downhill-Assist Control (DAC);
Intelligent speed adaptation or intelligent speed advice (ISA);
Lane departure warning system;
Lane change assistance (LCA);
Pedestrian protection system;
Traffic sign recognition;
Turning assistant;
Brake Assist;
Traction Control (TRC);
Vehicle Stability Control (VSC);
Vehicle Dynamics Integrated Management (VDIM);
Tire Pressure Monitoring System (TPMS);
Launch Control (LC);
Limited-slip differential (LSD);
Roll Stability Control or Electronic Roll Mitigation (RSC);
Evasive Steering Support or Collision mitigation steering;
Emergency Support Signal or Ecall (ESS);
Autonomous Emergency Braking (AEB); and/or
Lane Keep Assist (LKA), (LKAS).

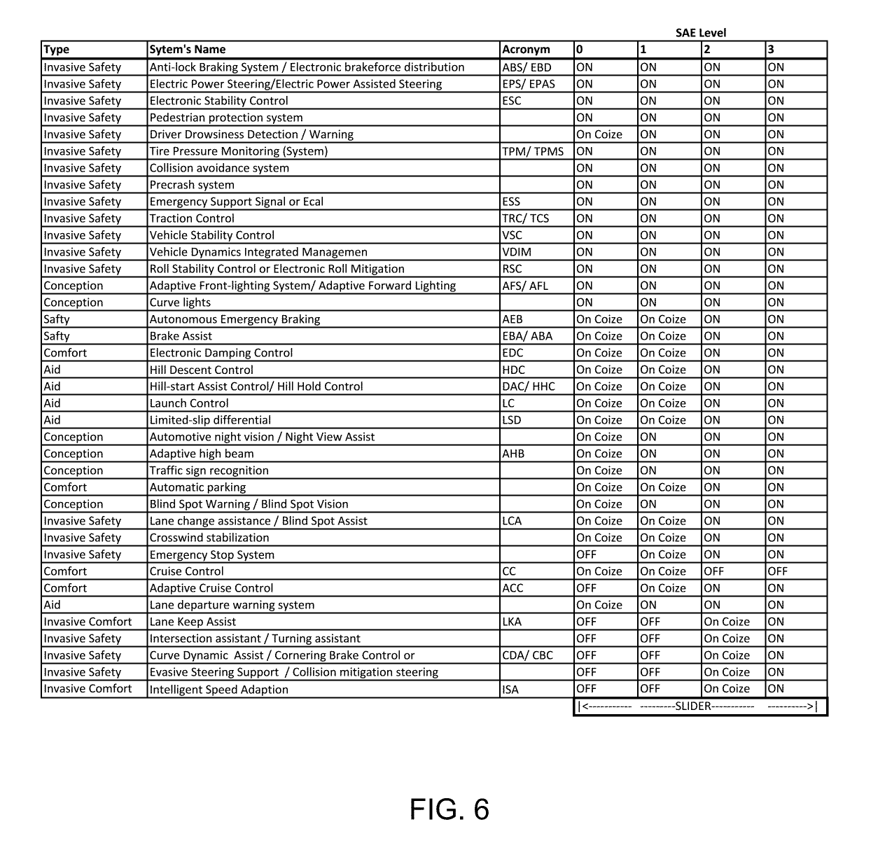

The point on the autometer slider at which a function or feature is switched or optionally offered for being engaged may be pre-set by the OEM or the supplier. FIG. 6 shows an exemplary chart having four levels of automation with the lowest level on the left according SAE Level 0, being the mode with no automation. Some of the basic driving safety systems (on the top line) may be on all the time. More and more systems get engaged when putting the slider more to the left. The lowest five line items correlate as necessary for providing highway pilot functionality (SAE Level 3). Optionally, there may be an OEM customized (branding) feature setting for various features, especially the features which underline the vehicle behavior that a brand is supposed to stand for such as BMW might more likely be seen more ‘sportive’ and a Volvo preferably seen as more ‘safe’, but both may also incorporate safe and sportive driving that is selectable by the driver. Optionally, the setting may be pre configurable by the driver. Optionally, the setting may be adaptable by an artificial intelligence (AI) algorithm supervising the driver and optionally all vehicle occupants so that there is always an optimal setting to the driver's or occupants' needs, mood, health level, age, education and experience level, drowsiness level and distraction level. The best AI setting adaption may be one where the driver will not even notice it to be present.

As shown in FIG. 3, the automatic driver assistance system (ADAS) of the vehicle may include a forward facing camera that views through the windshield of the vehicle, and a plurality of exterior cameras that have respective fields of view exterior of the vehicle (such as to provide views at the front, rear and both sides of the vehicle). The system may also include a plurality of radar sensors for object data capture and ultrasonic sensors. The data captured by the cameras and radar sensors and ultrasonic sensors is processed to provide images for display, to detect objects and other vehicles, to determine lane markings, and the like. Responsive to the processing, and responsive to the user input, the system can provide the desired level of control of the vehicle.

The cameras or sensors may comprise any suitable cameras or sensors. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EyeQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in International Publication Nos. WO/2010/144900; WO 2013/043661 and/or WO 2013/081985, and/or U.S. Pat. No. 9,126,525, which are hereby incorporated herein by reference in their entireties.

The system may also communicate with other systems, such as via a vehicle-to-vehicle communication system or a vehicle-to-infrastructure communication system or the like. Such car2car or vehicle to vehicle (V2V) and vehicle-to-infrastructure (car2X or V2X or V2I or 4G or 5G) technology provides for communication between vehicles and/or infrastructure based on information provided by one or more vehicles and/or information provided by a remote server or the like. Such vehicle communication systems may utilize aspects of the systems described in U.S. Pat. Nos. 6,690,268; 6,693,517; 7,156,796 and/or 7,580,795, and/or U.S. Publication Nos. US-2012-0218412, US-2012-0062743, US-2015-0251599; US-2015-0158499; US-2015-0124096; US-2015-0352953; US-2016-0036917 and/or US-2016-0210853, which are hereby incorporated herein by reference in their entireties.

The system may utilize sensors, such as radar or lidar sensors or the like. The sensing system may utilize aspects of the systems described in U.S. Pat. Nos. 8,027,029; 8,013,780; 6,825,455; 7,053,357; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 6,919,549; 6,906,793; 6,876,775; 6,710,770; 6,690,354; 6,678,039; 6,674,895 and/or 6,587,186, and/or International Publication No. WO 2011/090484 and/or U.S. Publication No. US-2010-0245066 and/or U.S. patent applications, Ser. No. 15/446,220, filed Mar. 1, 2017 (Attorney Docket MAG04 P-2955), and/or Ser. No. 15/420,238, filed Jan. 31, 2017 (Attorney Docket MAG04 P-2935), and/or U.S. provisional applications, Ser. No. 62/375,161, filed Aug. 15, 2016, Ser. No. 62/361,586, filed Jul. 13, 2016, Ser. No. 62/359,913, filed Jul. 8, 2016, Ser. No. 62/349,874, filed Jun. 14, 2016, Ser. No. 62/330,557, filed May 2, 2016, and/or Ser. No. 62/313,279, filed Mar. 25, 2016, which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,708,410; 5,737,226; 5,802,727; 5,878,370; 6,087,953; 6,173,501; 6,222,460; 6,513,252 and/or 6,642,851, and/or U.S. Publication Nos. US-2014-0022390; US-2012-0162427; US-2006-0050018 and/or US-2006-0061008, which are all hereby incorporated herein by reference in their entireties.

Optionally, the vision system (utilizing the forward viewing camera and a rearward viewing camera and other cameras disposed at the vehicle with exterior fields of view) may be part of or may provide a display of a top-down view or bird's-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, and/or U.S. Publication No. US-2012-0162427, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicle control system, said vehicle control system comprising:
a plurality of sensors disposed at a vehicle and having respective fields of sensing exterior of the vehicle;
a processor operable to process data captured by said sensors;
a control;
wherein said control, responsive to processing by said processor of data captured by said sensors, controls a plurality of vehicle systems, and wherein said control is capable of autonomous control of the vehicle to autonomously drive the vehicle along a road; and
a user input selectively actuatable by an occupant of the vehicle so that the occupant can select one of (i) a non-autonomous mode where the occupant has driving control of the vehicle and non-autonomously drives the vehicle along the road, and (ii) an autonomous mode where said control autonomously drives the vehicle along the road.

2. The vehicle control system of claim 1, comprising a driver monitoring system, wherein, responsive to said driver monitoring system, said control determines an appropriate control mode.

3. The vehicle control system of claim 2, wherein, responsive to said driver monitoring system determining that the occupant is not alert with the non-autonomous mode selected, said control overrides the selected mode and operates in the autonomous mode and autonomously drives the vehicle along the road.

4. The vehicle control system of claim 1, wherein, when the occupant of the vehicle selectively actuates said user input so that said control allows driver control of the vehicle, said control deactivates at least some automatic vehicle systems.

5. The vehicle control system of claim 4, wherein the deactivated automatic vehicle systems include at least some of (i) automatic braking, (ii) adaptive cruise control, (iii) lane keeping assist, (iv) steering assist and (v) acceleration control.

6. The vehicle control system of claim 1, wherein said user input is selectively actuated by the occupant of the vehicle to select a control mode from at least three control modes.

7. The vehicle control system of claim 6, wherein the at least three control modes include (i) the non-autonomous mode, (ii) a semi-autonomous mode and (iii) the autonomous mode.

8. The vehicle control system of claim 6, wherein the at least three control modes comprise four control modes including (i) the non-autonomous mode, (ii) a semi-autonomous mode, (iii) a conditional autonomous mode and (iv) the autonomous mode.

9. The vehicle control system of claim 1, wherein said plurality of sensors comprise a plurality of radar sensors disposed at the vehicle and having respective fields of sensing exterior of the vehicle.

10. The vehicle control system of claim 1, wherein said plurality of sensors comprise a plurality of cameras disposed at the vehicle and having respective fields of view exterior of the vehicle.

11. A vehicle control system, said vehicle control system comprising:
a plurality of sensors disposed at a vehicle and having respective fields of sensing exterior of the vehicle;
wherein said plurality of sensors comprise a plurality of radar sensors disposed at the vehicle and having respective fields of sensing exterior of the vehicle;
wherein said plurality of sensors comprise a plurality of cameras disposed at the vehicle and having respective fields of view exterior of the vehicle;
a processor operable to process data captured by said sensors;
a control;
wherein said control, responsive to processing by said processor of data captured by said sensors, controls a plurality of vehicle systems, and wherein said control is capable of autonomous control of the vehicle to autonomously drive the vehicle along a road; and
a user input that is selectively actuatable by an occupant of the vehicle so that the occupant can select one of (i) a non-autonomous mode where the occupant has driving control of the vehicle and non-autonomously drives the vehicle along the road, (ii) a semi-autonomous mode where said control controls one or more driver assist systems of the vehicle and (iii) an autonomous mode where said control autonomously drives the vehicle along the road.

12. The vehicle control system of claim 11, wherein, when the occupant of the vehicle selectively actuates said user input to select said partial autonomous mode, said control controls one or more driver assist systems selected from the group consisting of (i) automatic braking, (ii) adaptive cruise control, (iii) lane keeping assist, (iv) steering assist and (v) acceleration control.

13. The vehicle control system of claim 11, comprising a driver monitoring system, wherein, responsive to said driver monitoring system, said control determines an appropriate control mode.

14. The vehicle control system of claim 11, comprising a driver monitoring system, wherein, responsive to said driver monitoring system determining that the occupant is not alert with the non-autonomous mode selected, said control overrides the selected mode and operates in the autonomous mode and autonomously drives the vehicle along the road.

15. The vehicle control system of claim 11, wherein, when the occupant of the vehicle selectively actuates said user input to select the non-autonomous mode, said control deactivates at least some automatic vehicle systems, and wherein the deactivated automatic vehicle systems include at least some of (i) automatic braking, (ii) adaptive cruise control, (iii) lane keeping assist, (iv) steering assist and (v) acceleration control.

16. A vehicle control system, said vehicle control system comprising:
a plurality of sensors disposed at a vehicle and having respective fields of sensing exterior of the vehicle;
wherein said plurality of sensors comprise a plurality of radar sensors disposed at the vehicle and having respective fields of sensing exterior of the vehicle;
wherein said plurality of sensors comprise a plurality of cameras disposed at the vehicle and having respective fields of view exterior of the vehicle;
a processor operable to process data captured by said sensors;
a control;
wherein said control, responsive to processing by said processor of data captured by said sensors, controls a plurality of vehicle systems, and wherein said control is capable of autonomous control of the vehicle to autonomously drive the vehicle along a road;
a user input selectively actuatable by an occupant of the vehicle so that the occupant can select one of (i) a non-autonomous mode where the occupant has driving control of the vehicle and non-autonomously drives the vehicle along the road, and (ii) an autonomous mode where said control autonomously drives the vehicle along the road; and
a driver monitoring system, wherein, responsive to said driver monitoring system, said control determines an appropriate control mode, and wherein, responsive to said driver monitoring system determining that the occupant is not alert with the non-autonomous mode selected, said control overrides the selected mode and operates in the autonomous mode and autonomously drives the vehicle along the road.

17. The vehicle control system of claim 16, wherein said user input is selectively actuatable by the occupant of the vehicle so that the occupant can select one of (i) the non-autonomous mode, (ii) a semi-autonomous mode where said control controls, at least in part responsive to processing by said processor of captured data, at least one of steering, acceleration and deceleration of the vehicle, (iii) a conditional autonomous mode where said control autonomously drives the vehicle along the road but requires that the occupant be present and capable of taking driving control of the vehicle and (iv) the autonomous mode.

18. The vehicle control system of claim 17, wherein, when the occupant of the vehicle selectively actuates said user input so that said control allows driver control of the vehicle, said control deactivates at least some automatic vehicle systems, and wherein the deactivated automatic vehicle systems include at least some of (i) automatic braking, (ii) adaptive cruise control, (iii) lane keeping assist, (iv) steering assist and (v) acceleration control.

19. The vehicle control system of claim 16, wherein said plurality of sensors comprise a plurality of radar sensors disposed at the vehicle and having respective fields of sensing exterior of the vehicle.

20. The vehicle control system of claim 16, wherein said plurality of sensors comprise a plurality of cameras disposed at the vehicle and having respective fields of view exterior of the vehicle.
